(19) United States
(12) Patent Application Publication
(10) Pub. No.: US 2023/0142475 A1
(43) Pub. Date: May 11, 2023

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Shigeki NIMIYA, Yokohama Kanagawa (JP)

(21) Appl. No.: 17/840,946

(22) Filed: Jun. 15, 2022

(30) Foreign Application Priority Data
Nov. 11, 2021 (JP) 2021-184349

(51) Int. Cl. G06Q 30/02; G06Q 10/08; G06Q 30/06

(52) U.S. Cl. CPC G06Q 30/0241; G06Q 10/087; G06Q 30/0623

(57) ABSTRACT

According to an embodiment, an information processing apparatus acquires, where a product has arrived at a store, product identification information for identifying the arrived product. The information processing apparatus outputs, upon acquiring the product identification information, advertisement information of a product identified by the product identification information to an information terminal of a consumer.

### CROSS-REFERENCE TO RELATED APPLICATIONS

This application is based upon and claims the benefit of priority from the prior Japanese Patent Application No. 2021-184349, filed on Nov. 11, 2021, the entire contents of which are incorporated herein by reference.

### FIELD

An embodiment to be described here generally relates to an information processing apparatus and an information processing method.

### BACKGROUND

In the past, a system for improving the sales of products replenished in sales floors in stores selling products has been proposed. As an example, a system that recognizes the products displayed in a sales floor by imaging the situation of the sales floor and backyard and advertises the recognized products by signage or the like disposed in the store has been proposed.

However, the existing system advertises a product when the product is replenished in the sales floor, and is not always satisfactory for customers who want to more quickly know information regarding the products to be sold.

### BRIEF DESCRIPTION OF THE DRAWINGS

FIG. 1 is a diagram showing an outline of an advertisement information delivery system including an information processing apparatus according to an embodiment;

FIG. 2 is a block diagram showing a hardware configuration of the information processing apparatus according to the embodiment;

FIG. 3 is a diagram showing a data configuration of a member master stored in a memory of the information processing apparatus according to the embodiment;

FIG. 4 is a diagram showing a data configuration of a product master stored in the memory of the information processing apparatus according to the embodiment;

FIG. 5 is a diagram showing a data configuration of a purchase information management file stored in the memory of the information processing apparatus according to the embodiment;

FIG. 6 is a diagram showing a data configuration of an inventory management file stored in the memory of the information processing apparatus according to the embodiment;

FIG. 7 is a diagram showing a data configuration of an order management file stored in the memory of the information processing apparatus according to the embodiment;

FIG. 8 is a diagram showing a data configuration of a property classification file stored in the memory of the information processing apparatus according to the embodiment;

FIG. 9 is a diagram showing a data configuration of a product property information file stored in the memory of the information processing apparatus according to the embodiment;

FIG. 10 is a diagram showing a data configuration of a consumer property information file stored in the information processing apparatus according to the embodiment;

FIG. 11 is a block diagram showing a functional configuration of a controller of the information processing apparatus according to the embodiment;

FIG. 12 is a flowchart showing consumer-property-information-management processing by the controller of the information processing apparatus according to the embodiment;

FIG. 13 is a flowchart showing advertisement information output processing by the controller of the information processing apparatus according to the embodiment;

FIG. 14 is a flowchart showing order information reception processing by the controller of the information processing apparatus according to the embodiment;

FIG. 15 is a block diagram showing a configuration of a memory of an information processing apparatus according to a modification of the embodiment; and

FIG. 16 is a diagram showing a data configuration of an individual-item-property-information file stored in the memory of the information processing apparatus according to the modification of the embodiment.

### DETAILED DESCRIPTION

According to an embodiment, an information processing apparatus acquires information regarding a product from a store sever that manages inventory information of products in a store and controls delivery of advertisement information to an information terminal of a consumer. The information processing apparatus includes a communication device, a memory, and a controller. The communication device communicates with the store server and the information terminal. The memory includes a product master file for storing product information regarding a product. The controller acquires, where a product had arrived at the store, product identification information for identifying the arrived product from the store server via the communication device. Further, the controller outputs advertisement information based on the product information stored in the product master file in association with the acquired product identification information to the information terminal via the communication device.

Hereinafter, an information processing apparatus, an information processing method, and a program according to an embodiment will be described with reference to the drawings. In the drawings, the same reference symbols indicate the same or similar portions. Note that the embodiment is not limited to the following description. For example, in the embodiment described below, an example in which an information processing apparatus is used as a headquarters server managed by the headquarters of a company that operates a plurality of stores will be described, but the information processing apparatus may be a store server that manages a store. Further, the information processing apparatus may be a server that is connected to servers of a plurality of companies and manages information regarding these companies.

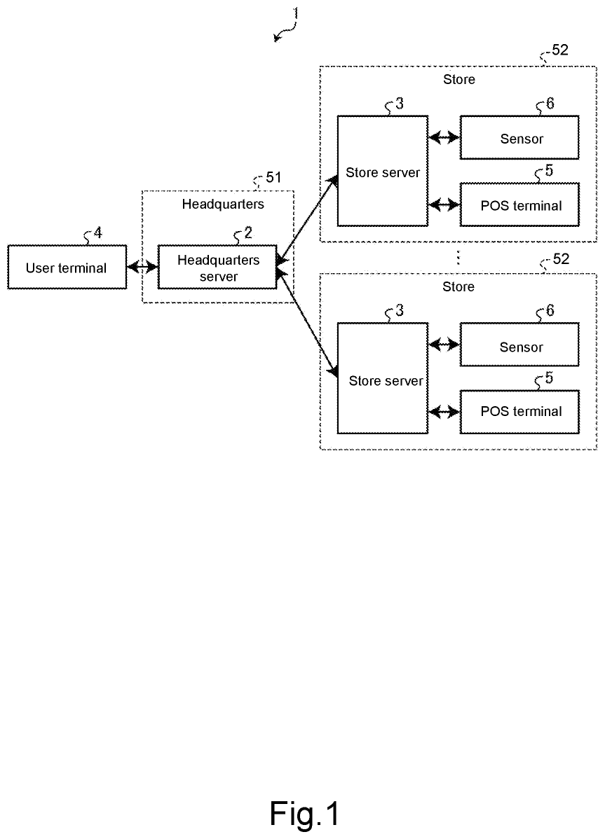

FIG. 1 is a diagram showing an outline of an advertisement information delivery system 1. The advertisement information delivery system 1 according to this embodiment is applied to a company that operates a plurality of stores. The advertisement information delivery system 1 includes a headquarters server 2 provided in headquarters 51, a store server 3 provided in each store 52, and a user terminal 4 owned by a member (hereinafter, referred to also as the “consumer”) of a company that operates the respective stores 52.

The headquarters server 2 is communicably connected to the store server 3 of each of the stores 52 via a network such as the Internet and a dedicated line. Further, the headquarters server 2 is communicably connected to v via a network such as the Internet.

The headquarters server 2 functions as an inventory management server that manages the inventory of each store 52, an advertisement delivery server that outputs advertisement information to the user terminal 4, a consumer management server that manages information regarding a consumer, and an order management server that manages an order from the user terminal 4.

Specifically, the headquarters server 2 acquires, when a product had arrived at each store 52, product information regarding the product that has arrived (hereinafter, referred to also as the “arrived product”) and purchase information of a product traded at each store 52 from the store server 3, and manages the inventory state of products in each store 52 on the basis of these pieces of information.

Further, the headquarters server 2 transmits, upon acquiring the product information of the arrived product from the store server 3 when the product had arrived, the advertisement information relating to the arrived product to the user terminal 4. For example, the headquarters server 2 transmits, at the time point of the arrival of a product, the advertisement information of the arrived product to the user terminal 4 of a consumer who matches the properties of the arrived product, in other words, a consumer who is thought to have a high possibility of purchasing the arrived product. Here, the phrase “when a product had arrived” includes the period from when the product is delivered to the store 52 to when the product is displayed. In this embodiment, the headquarters server 2 acquires product information when the product information is read by a sensor at the time of receiving a delivered product in the store 52. In other words, the headquarters server 2 promptly acquires, when a product is delivered to the store 52, product information of the product.

As a result, the headquarters server 2 is capable of more quickly providing advertisement information to a consumer by utilizing product information of the arrived product, which is information obtained when a product has arrived and is for managing the inventory state of each store 52. Therefore, the store 52 is capable of achieving a sales strategy such as delivering advertisement information to excellent customers at an earlier stage. Further, the consumer can order, using the user terminal 4, the arrived product that matches himself/herself more quickly, e.g., before the arrived product is displayed on a sales floor, by acquiring the advertisement information described above.

The headquarters server 2 manages information regarding properties of a consumer and the like on the basis of the purchase information acquired from the store server 3. For example, the headquarters server 2 registers and updates, from information registered by a consumer himself/herself and the purchasing tendency of the consumer, property information (preference, purchase time zone, type of purchased product, and the like) of the consumer. Further, the headquarters server 2 manages the orders received from the user terminal 4. The headquarters server 2 is an example of the information processing apparatus. The headquarters server 2 may include a plurality of computers and may be realized by cloud computing.

The store server 3 is provided in each store 52. The store server 3 is communicably connected to a POS (Point Of Sales) terminal 5 and a sensor 6 installed in the store 52 via a network such as a LAN (Local Area Network). The POS terminal 5 executes payment processing of products purchased by a consumer in the store 52. The sensor 6 includes, for example, a scanner and an RFID (Radio Frequency Identification) reading device and reads, from the code symbol such as the barcode and the two-dimensional code, the wireless tag, or the like attached to the arrived product, the product code, the product information, or the individual code of the product. The product code is an example of the product identification information, and the individual code is an example of the individual-item identification information.

The store server 3 acquires, from the POS terminal 5, purchase information including a member ID, a product code and product information of the purchased product, a transaction amount, and the like, and manages sales information of the store 52. Further, the store server 3 manages inventory information of products in the store 52 on the basis of the product information of the arrived product acquired from the sensor 6 and the sales information described above. When the store server 3 acquires the product information of the arrived product from the sensor 6, the store server 3 immediately transmits the product information to the headquarters server 2. Further, the store server 3 transmits the purchase information to the headquarters server 2 every time a transaction is made.

Note that in this embodiment, the store 52 is in a form of selling products in the store 52, e.g., a product is sold for a consumer who came to the store after ordering the product by the user terminal 4 in advance or a consumer who came to the store without ordering the product. However, the sales form of products is not limited thereto, and may be a sales form by only so-called Internet sales in which the order and payment are completed by the user terminal 4 and the product is delivered to the consumer's home or a sales form in which sales at the store 52 and the Internet sales are combined with each other.

The user terminal 4 is an information terminal such as a smartphone and a PC (Personal Computer) owned by a consumer. The e-mail address of the user terminal 4 is registered in the headquarters server 2 when the consumer registers as a member, and the user terminal 4 is capable of receiving advertisement information from the headquarters server 2. Further, the user terminal 4 is capable of also ordering a product in each store 52 by accessing the headquarters server 2.

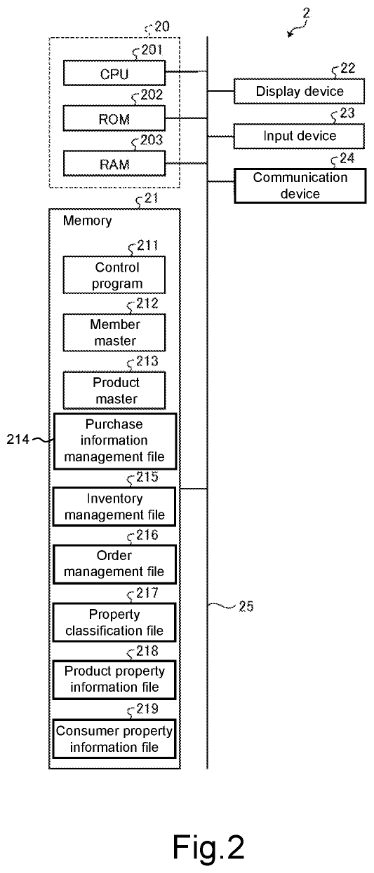

Next, the headquarters server 2 will be described in detail. FIG. 2 is a block diagram showing a main hardware configuration of the headquarters server 2. The headquarters server 2 includes a controller 20, a memory 21, a display device 22, an input device 23, and a communication device 24. The controller 20, the memory 21, the display device 22, the input device 23, and the communication device 24 are connected to each other via a bus 25 or the like.

The controller 20 includes a computer including a processor 201, a ROM (Read Only Memory) 202, and a RAM (Random Access Memory) 203. The processor 201, the ROM 202, and the RAM 203 are connected to each other via the bus 25.

The processor 201 is, for example, a CPU (Central Processing Unit). The processor 201 will be referred to as the CPU 201 in some cases. The CPU 201 controls the operation of the entire headquarters server 2. The ROM 202 stores various programs such as a program used for driving the CPU 201 and various types of data. The RAM 203 is used as a work area of the CPU 201, and expands various programs and various types of data stored in the ROM 202 and the memory 21. When the CPU 201 operates in accordance with the control program that is stored in the ROM 202 or the memory 21 and expanded into the RAM 203, the controller 20 executes various types of control processing of the headquarters server 2.

The memory 21 includes a storage medium such as an HDD (Hard Disk Drive) and a flash memory, and maintains the stored content even when the power is cut off. The memory 21 stores a control program 211, a member master 212, a product master 213, a purchase information management file 214, an inventory management file 215, an order management file 216, a property classification file 217, a product property information file 218, and a consumer property information file 219.

The control program 211 includes a program that causes the headquarters server 2 to function as an inventory management server that manages the inventory of each store 52, a program that causes the headquarters server 2 to function as an advertisement delivery server that outputs advertisement information to the user terminal 4, a program that causes the headquarters server 2 to function as a consumer management server that manages information regarding a consumer, a program that causes the headquarters server 2 to function as an order management server that manages an order from the user terminal 4, and the like.

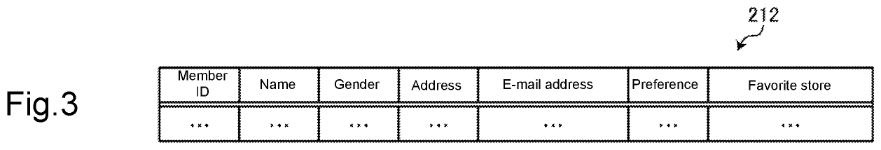

The member master 212 is a master file that stores information regarding a consumer who is a member of a company. FIG. 3 is a diagram showing a data configuration of the member master 212. Each piece of data registered in the member master 212 is associated with information indicating a member ID, a name, a gender, an address, an e-mail address, a preference, and a favorite store. Each piece of information registered in the member master 212 is information provided from a customer himself/herself when he/she registers as a member.

A member ID for identifying a member is registered in the item of the member ID. The member ID is an example of the consumer identification information. Information indicating the name of the member is registered in the item of the name. Information indicating the gender of the member is registered in the item of the gender. Information indicating the address of the member is registered in the item of the address. The e-mail address of the user terminal 4 owned by the member is registered in the item of the e-mail address.

Information relating to the preference of the member is registered in the item of the preference. The information relating to the preference is information relating to a product sold by the store 52. The information relating to the preference is, for example, information indicating vegetables, meat, or fish like in the case where the store 52 is a supermarket, or information indicating colors, types, or materials in the case where the store 52 is a clothing store. In this embodiment, the store 52 will be described as a supermarket. Information indicating a store frequently used by the member is registered in the item of the favorite store. The information relating to the preference and the information relating to the favorite store can be used as property information indicating the properties of a consumer described below.

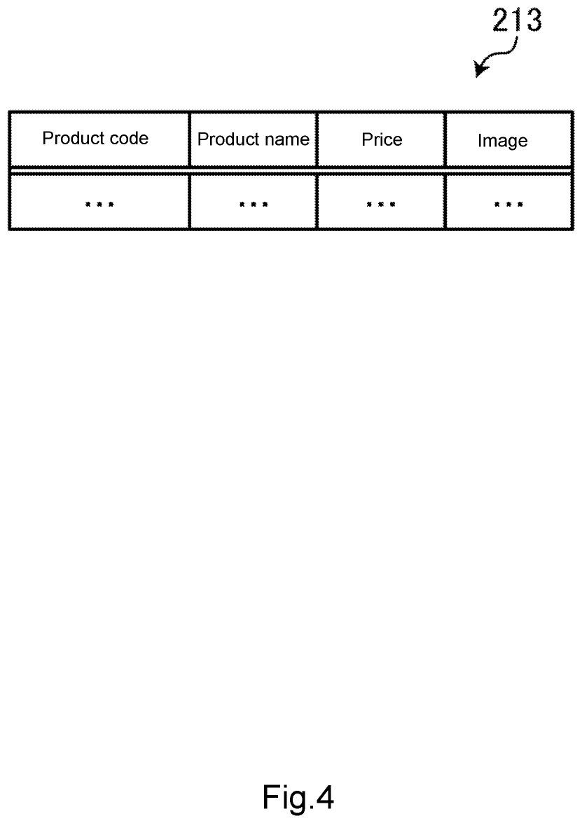

The product master 213 is a master file for storing the product sold in each store 52 in association with the product code and the product information. Since the product sold in each store 52 is changed daily, the product master 213 is updated as appropriate. FIG. 4 is a diagram showing a data configuration of the product master 213. Each piece of data registered in the product master 213 is associated with information indicating a product code, a product name, a price, and an image. The product master 213 is an example of the product file for storing product identification information and product information relating to a product in association with each other. Further, the information indicating a product name, a price, and an image is an example of the product information.

A product code for identifying a product is registered in the item of the product code. Information indicating the name of a product is registered in the item of the product name. Information indicating the unit price of a product is registered in the item of the price. The price may be an amount of the pre-tax price of a product including the consumption tax or may be the pre-tax price including no consumption tax. Data of a product image is registered in the item of the image. The product image is a photograph, an illustration, or the like.

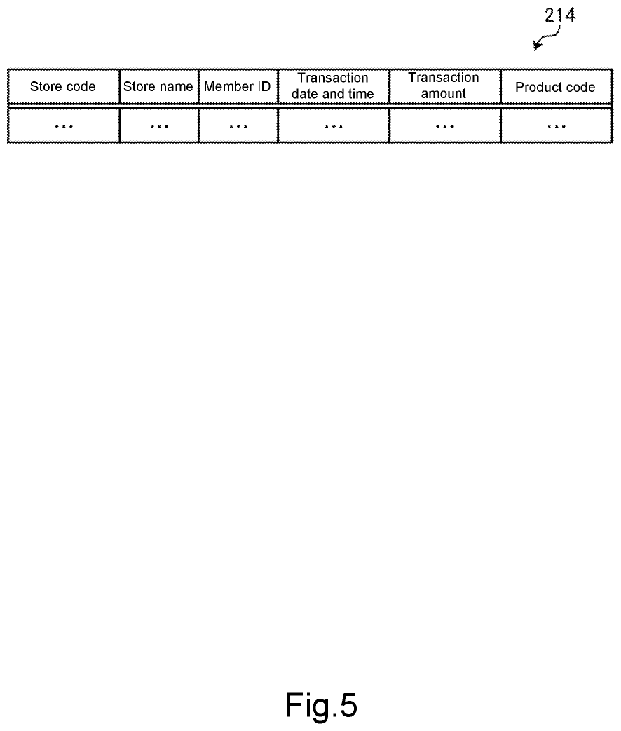

The purchase information management file 214 is a file for managing the purchase information of each store 52 for each transaction. The purchase information management file 214 is updated on the basis of the purchase information received from the store server 3 o each store 52. FIG. 5 is a diagram showing a data configuration of the purchase information management file 214. Each piece of data registered in the purchase information management file 214 is associated with information indicating a store code, a store name, a member ID, a transaction date and time, a transaction amount, and a product code.

A store code for identifying a store where a transaction has been made is registered in the item of the store code. Information indicating the name of a store where a transaction has been made is registered in the item of the store name. A member ID for identifying a consumer who has purchased a product in the transaction is registered in the item of the member ID. Information indicating the date and time when the transaction was made, i.e., the date and time when a consumer purchased a product, is registered in the item of the transaction date and time.

Information indicating a transaction amount of one transaction is registered in the item of the transaction amount. A product code of the traded product is registered in the item of the product code. In the case where a plurality of product has been purchased in one transaction, a plurality of product codes is registered in the item of the product code. Note that in the case where a company manages products in individual item units as in a modification described below, the individual code for identifying the individual item is also registered in the purchase information management file 214.

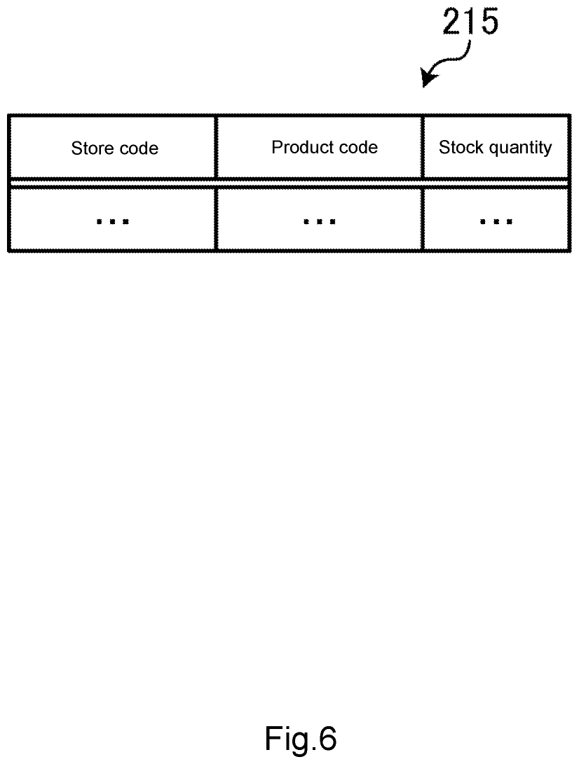

The inventory management file 215 is a file for managing the inventory state of products in each store 52. In other words, the inventory management file 215 stores inventory information indicating the stock quantity of each product present in each store 52. The inventory management file 215 is updated on the basis of the product code and purchase information of the arrived product received from the store server 3 of each store 52. FIG. 6 is a diagram showing a data configuration of the inventory management file 215. Each piece of data registered in the inventory management file 215 is associated with information indicating a store code, a product code, and the stock quantity. Note that the inventory management file 215 may store the arrival date and time and the arrival quantity in association with the data, and may manage the stock quantity for each product arrived at one time.

A store code for identifying a store that sells a product is registered in the item of the store code. A product code for identifying a product is registered in the item of the product code. Information indicating the stock quantity of the product identified by the corresponding product code is registered in the item of the stock quantity. When the product code of the arrived product and information indicating the arrival quantity have been received from the store server 3, the stock quantity corresponding to the product code is added by the arrival quantity. Further, when purchase information including the product code and the sales quantity has been received from the store server 3, the stock quantity corresponding to the product code is subtracted by the sales quantity. Note that in the case where a company manages products in individual item units, the individual code may be registered also in the inventory management file 215.

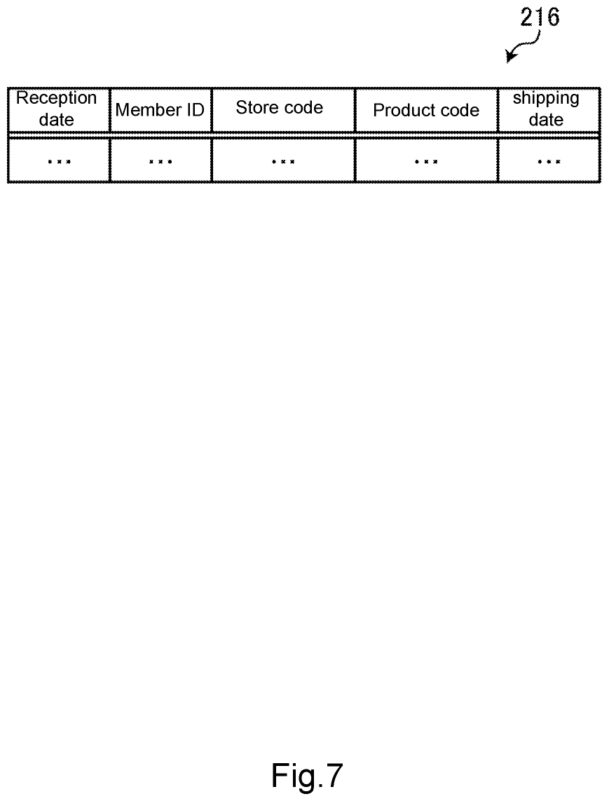

The order management file 216 is a file for managing orders received from the user terminal 4 for products sold in each store 52. In the order management file 216, order data is registered when an order has been received from the user terminal 4 and the order data is updated when information indicating that a product has been shipped has been received from the store server 3. FIG. 7 is a diagram showing a data configuration of the order management file 216. Each piece of registered in the order management file 216 is associated with information indicating a reception date, a member ID, a store code, a product code, and a shipping date.

Information indicating the date when an order has been received from the user terminal 4 is registered in the item of the reception date. A member ID for identifying a consumer who has ordered a product is registered in the item of the member ID. A store code for identifying a store designated by the consumer who has ordered a product is registered in the item of the store code. The consumer who has ordered a product can purchase the product at the store identified by the store code. Note that in the case where Internet sales in which the ordered product is delivered to the consumer's home is performed, the controller 20 stores a store code in accordance with the inventory state of each store 52. In other words, in the case of Internet sales, the store code is registered not by the consumer who has ordered a product but by a company that has received an order.

A product code for identifying the ordered product is registered in the item of the product code. Information indicating the date when the ordered product was shipped to the consumer is registered in the item of the shipping date. The information indicating the shipping date is registered on the basis of shipping information or purchase information received from the store server 3 of the store identified by the corresponding store code.

The property classification file 217 is a file that defines property information used for matching between a product and a consumer executed for selecting a consumer to which advertisement information of the arrived product is transmitted. The property classification file 217 stores information obtained by dividing the property information into major classification and minor classification. Note that the property classification file 217 may classify the property information into more detailed classifications, e.g., major classification, middle classification, and minor classification.

The property information only needs to one capable of matching a product and a consumer with each other and can be arbitrarily set by a company that operates the store 52. For example, as property information, information relating to the content of a product or information relating to the sales time zone can be adopted. It can be said that the property information of major classification and minor classification registered in the property classification file 217 is property information indicating the properties of a product and property information indicating the properties of a consumer.

As an example, a vegetable can be set in in the major classification of the property information relating to the content of a product, and the type of the vegetable such as a lettuce and a tomato can be set in the corresponding minor classification. Alternatively, meat can be set in the major classification, and the type of the meat such as beef and pork can be set in the corresponding minor classification. Further, fish can be set in the major classification, and the type of the fish such as tuna and saury in the corresponding minor classification. Further, a meal time zone can be set in the major classification of property information relating to the sales time zone, and a breakfast time zone, a lunch time zone, and a dinner time zone can be set in the corresponding minor classification.

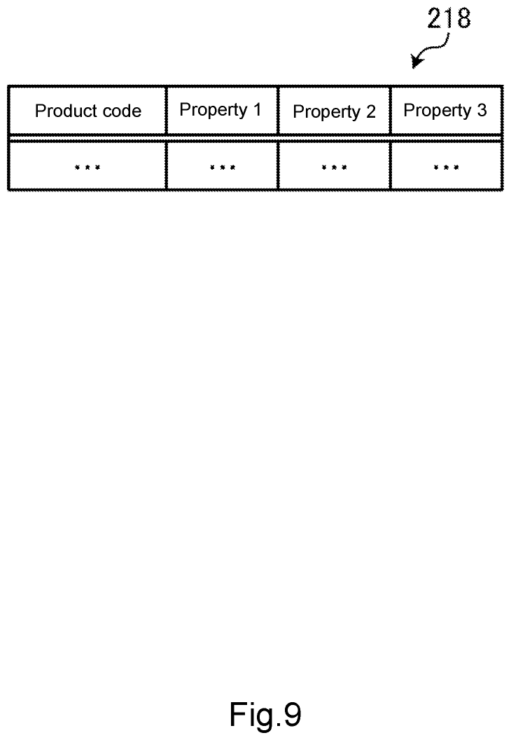

The product property information file 218 is a file for storing property information predetermined by a company for each product, and stores a product code that is product identification information and property information indicating the properties of a product in association with each other. FIG. 9 is a diagram showing a data configuration of the product property information file 218. Each piece of data registered in the product property information file 218 is associated with information indicating a product code, a property 1, a property 2, and a property 3. Note that the number of pieces of property information determined in advance in accordance with the product code is not limited to three, and can be arbitrarily set. Further, the number of pieces of property information may be changed for each product.

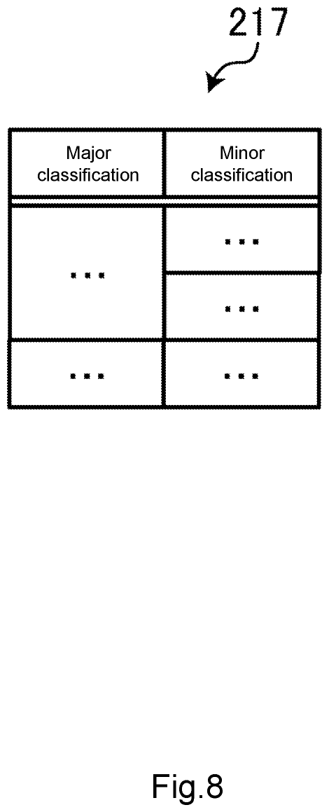

A product code for identifying a product is registered in the item of the product code. Property information indicating the property of a product is registered in the item of each of the property 1, the property 2, and the property 3. The property information registered in the item of each of the property 1, the property 2, and the property 3 is property information stored in the major classification of the property classification file 217 (see FIG. 8) or property information stored in the minor classification.

In the case where the product code indicates “organic vegetable lunch box”, for example, the following information is registered in the item of each of the property 1, the property 2, and the property 3.

Since the product is a type of lunch box, information indicating a “lunch box” is registered in the item of the property 1. Further, since the product mainly includes vegetables, information indicating “vegetables” is registered in the item of the property 2. Further, since the product is often purchased in a meal time zone, information indicating a “meal time zone” is registered in the item of the property 3. Note that in the case where the organic vegetable lunch box is sold only during a dinner time zone, a “dinner time zone” corresponding to the minor classification of the “meal time zone” in the property classification file 217 may be registered in the item of the property 3.

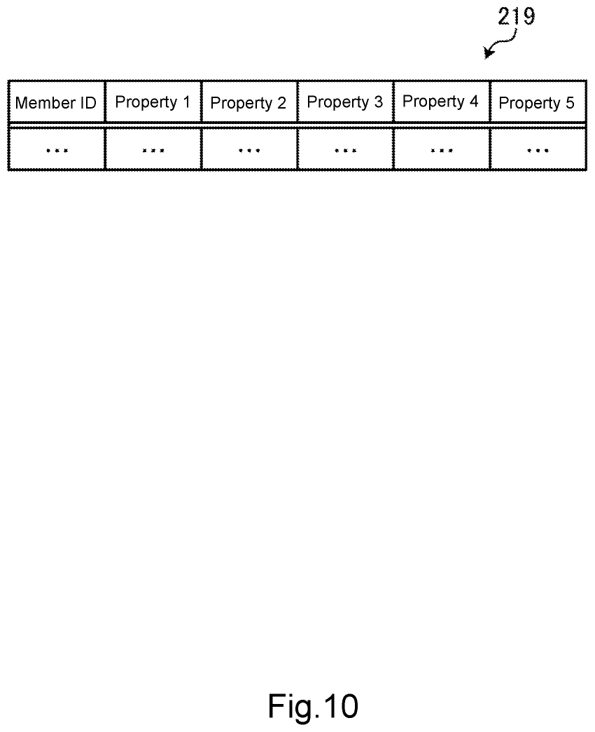

The consumer property information file 219 is a file for storing property information for each consumer, and stores a member ID that is consumer identification information and property information in association with each other. The consumer property information file 219 is generated and updated on the basis of the information of the member master 212 registered by the consumer and the purchase information acquired from the store server 3 of each store 52. FIG. 10 is a diagram showing a data configuration of the consumer property information file 219. Each piece of data registered in the consumer property information file 219 is associated with information indicating a member ID, the property 1, the property 2, the property 3, a property 4, and a property 5. Note that the number of pieces of property information set in association with the member ID is not limited to five, and can be arbitrarily set. Further, the number of pieces of property information may be changed for each consumer.

A member ID for identifying a consumer is registered in the item of the member ID. Property information indicting the property of the consumer is registered in the item of each of the property 1, the property 2, the property 3, the property 4, and the property 5. The property information registered in the item of each of the property 1, the property 2, the property 3, the property 4, and the property 5 is the property information stored in the major classification of the property classification file 217 (see FIG. 8) or the property information stored in the minor classification, similarly to the property information registered in the product property information file 218 (see FIG. 9). This makes it possible to match a product and a consumer with each other using the property information.

For example, pieces of information registered in the items of the preference and the favorite store of the member master 212 (see FIG. 3) are registered in the items of the property 1 and the property 2. In more detail, information indicating “vegetables” registered in the item of the preference of the member master 212 is registered in the item of the property 1, and information indicating a “store A” registered in the item of the favorite store of the member master 212 is registered in the item of the property 2.

Further, information registered in the item of each of the property 3, the property 4, and the property 5 is specific information selected as a result of analyzing the purchase information acquired from the store server 3 of each store 52. For example, the controller 20 extracts all pieces of property information corresponding to all the products purchased by the consumer identified by the member ID in a predetermined time period. The controller 20 then registers the top three pieces of property information with a large number of extractions are registered in the items of the property 3, the property 4, and the property 5 of the consumer property information file 219. As a result, for example, a “lunch box”, a “frozen food”, and a “dinner time zone” are respectively registered in the items of the property 3, the property 4, and the property 5. Note that the method of analyzing purchase information is not limited to the above. Further, the property information selected on the basis of purchase information is updated periodically (e.g., once a month).

The hardware configuration of the headquarters server 2 will be described with reference to FIG. 2 again.

The display device 22 is, for example, a liquid crystal panel and displays various types of information. The display device 22 displays, for example, the information stored in the member master 212, the product master 213, the purchase information management file 214, the inventory management file 215, the order management file 216, the property classification file 217, the product property information file 218, and the consumer property information file 219 as necessary.

The input device 23 inputs information to the controller 20. The input device 23 includes, for example, a keyboard, a touch panel, and a mouth.

The communication device 24 is an interface for communicating with an external apparatus such as the store server 3 of each store 52 and the user terminal 4 of each consumer. The controller 20 is capable of transmitting/receiving information (data) to/from an external apparatus by being connected to the external apparatus via the communication device 24.

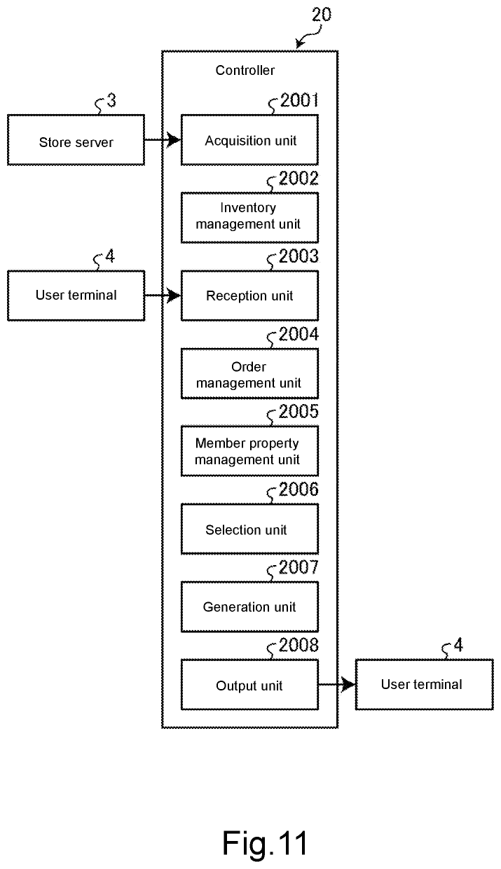

Subsequently, the functional configuration of the controller 20 of the headquarters server 2 will be described. FIG. 11 is a block diagram showing a main functional configuration of the controller 20 of the headquarters server 2. When the CPU 201 operates in accordance with the control program stored in the ROM 202 or the memory 21, the controller 20 functions as an acquisition unit 2001, an inventory management unit 2002, a reception unit 2003, an order management unit 2004, a member property management unit 2005, a selection unit 2006, a generation unit 2007, and an output unit 2008. Note that the respective functions may be realized by hardware such as a dedicated circuit.

The acquisition unit 2001 of the controller 20 acquires product identification information for identifying a product that has arrived. Specifically, the acquisition unit 2001 acquires, from the store server 3, arrival information including the product code read by the sensor 6 from the code symbol (barcode, two-dimensional code, etc.), the wireless tag, or the like attached to the arrived product. The arrival information acquired by the acquisition unit 2001 includes also an arrival code indicating that a product has arrived, a store code indicating the store 52 at which a product has arrived, an individual code for identifying the individual item of the arrived product, and information indicating the arrival date and time.

Further, the acquisition unit 2001 of the controller 20 acquires, from the store server 3, purchase information including consumer identification information and product identification information of a product purchased by the consumer identified by the consumer identification information. The purchase information is purchase information relating to a transaction paid by the POS terminal 5 of the store 52. Note that in the case of Internet sales, the acquisition unit 2001 acquires, for example, purchase information relating to credit card payment from the user terminal 4. The acquisition unit 2001 is an example of the purchase information acquisition unit. It can be said that the purchase information is shipping information indicating that the product ordered by the user terminal 4 has been shipped to the consumer.

The inventory management unit 2002 of the controller 20 updates, on the basis of the product identification information acquired by the acquisition unit 2001, the inventory management file 215 for storing the inventory information of products. Further, the inventory management unit 2002 updates the inventory management file 215 on the basis of the purchase information acquired by the acquisition unit 2001. In more detail, the inventory management unit 2002 registers various types of information in the inventory management file 215 or updates the various types of registered information on the basis of the product code of the arrived product acquired by the acquisition unit 2001, number-of-products information corresponding to the product code, the store code of the store at which a product has arrived, and the like.

Further, the inventory management unit 2002 updates, on the basis of the product code included in the purchase information acquired by the acquisition unit 2001, the number-of-products information corresponding to the product code, the store code of the store where the product has been sold, and the like, the various types of information registered in the inventory management file 215.

The reception unit 2003 of the controller 20 receives order information from the user terminal 4. The order information includes a member ID of a consumer who has ordered a product, a product code of the ordered product, number-of-products information indicating the number of ordered products, a store code of a store where the consumer receives the product, and the like.

The order management unit 2004 of the controller 20 manages the order information received by the reception unit 2003. Specifically, the order management unit 2004 registers the order information received by the reception unit 2003 in the order management file 216. Further, the order management unit 2004 recognizes, on the basis of the member ID, the product code, the transaction date and time, and the like included in the purchase information acquired by the acquisition unit 2001, that the ordered product has been shipped. The order management unit 2004 then registers information indicating the shipping date in the item of the shipping date of the order management file 216.

The member property management unit 2005 of the controller 20 updates the consumer property information file 219 on the basis of the purchase information acquired by the acquisition unit 2001. The member property management unit 2005 analyzes, on the basis of the purchase history of a consumer, the properties of the consumer. The member property management unit 2005 manages the properties of the consumer by the consumer property information file 219.

Specifically, the member property management unit 2005 registers, in the items of the property 1 and the property 2 of the consumer property information file 219, information registered in the items of the preference and the favorite store of the member master 212. Further, the member property management unit 2005 extracts, on the basis of the purchase information in a predetermined time period (e.g., one month) acquired from the store server 3 of each store 52, all pieces of property information corresponding to all the products purchased by one consumer. The member property management unit 2005 then registers the top three pieces of property information with a large number of extractions in the items of the property 3, the property 4, and the property 5 of the consumer property information file 219 or updates them. The member property management unit 2005 periodically updates each of the items of the property 3, the property 4, and the property 5 of the consumer property information file 219. The member property management unit 2005 is an example of the updating unit.

When the acquisition unit 2001 has acquired product identification information, the selection unit 2006 of the controller 20 refers to the product property information file 218 and the consumer property information file 219 to select a consumer to be provided with advertisement information. As described above, the product property information file 218 stores the product identification information and property information indicating the properties of a product in association with each other. The consumer property information file 219 stores consumer identification information for identifying a consumer and the property information in association with each other.

Specifically, the selection unit 2006 extracts, from the product property information file 218, the property information corresponding to the product code acquired from the acquisition unit 2001. The selection unit 2006 then selects the consumer identified by the consumer identification information corresponding to the extracted property information in the consumer property information file 219. The selection unit 2006 is an example of the first selection unit.

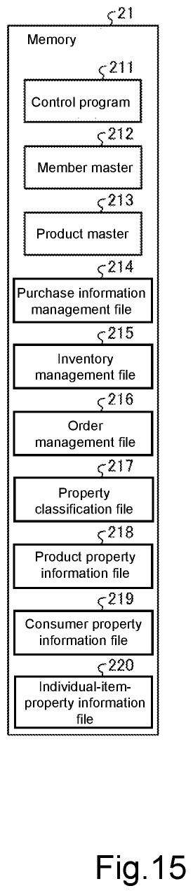

Further, when the acquisition unit 2001 has acquired the individual-item identification information, the selection unit 2006 may refer to an individual-item-property-information file 220 (see FIG. 15) and the consumer property information file 219 to select a consumer to be provided with advertisement information. As described above, the individual-item-property-information file 220 stores the individual-item identification information and the property information indicating properties of a product in association with each other.

Specifically, the selection unit 2006 extracts, from the individual-item-property-information file 220, the property information corresponding to the individual code acquired by the acquisition unit 2001. The selection unit 2006 then selects the consumer identified by the consumer identification information corresponding to the extracted property information in the consumer property information file 219. The selection unit 2006 is also an example of the second selection unit.

The generation unit 2007 of the controller 20 extracts, from the product file for storing product identification information and product information relating to a product in association with each other (the product master 213), the product information corresponding to the product identification information acquired by the acquisition unit 2001. The generation unit 2007 then generates advertisement information on the basis of the product information.

Specifically, the generation unit 2007 extracts, from the product master 213, product information including the product name, the price, the product image, and the like corresponding to the product code acquired by the acquisition unit 2001. The generation unit 2007 then takes in the product information into, for example, a preset format and generates advertisement information to be transmitted to the user terminal 4. The format can be arbitrarily set. Note that when the acquisition unit 2001 has acquired the product code of the arrived product, the generation unit 2007 may set a format of the advertisement information. Further, the generation unit 2007 may generate advertisement information including discount information or the like acquired by the acquisition unit 2001 from the store server 3.

When the acquisition unit 2001 has acquired the product identification information, the output unit 2008 of the controller 20 outputs, to the user terminal 4 of the consumer, the advertisement information of the product identified by the product identification information. Specifically, the output unit 2008 outputs the advertisement information generated by the generation unit 2007 to the user terminal 4 of the consumer selected by the selection unit 2006.

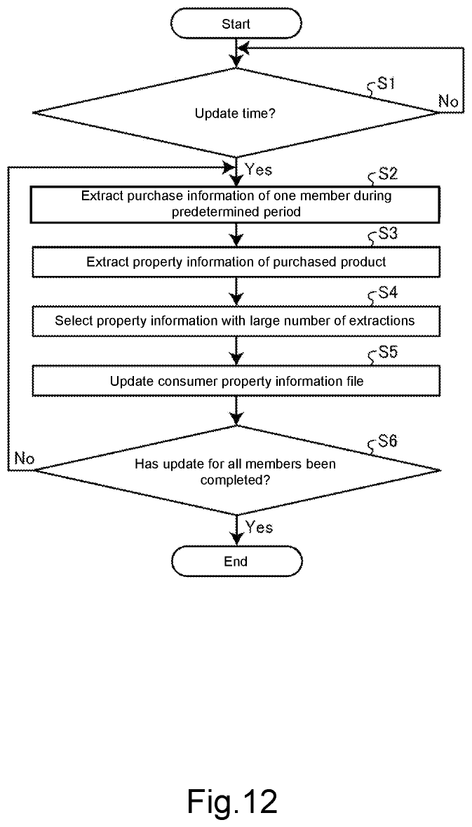

Next, consumer-property-information-management processing executed by the headquarters server 2 having the configuration described above will be described. The consumer-property-information-management processing is processing for updating the consumer property information file 219 (see FIG. 10). FIG. 12 is a flowchart showing consumer-property-information-management processing executed by the controller 20.

In Step S1 shown in FIG. 12, the controller 20 determines whether or not a preset update date (e.g., the first day of each month) has been reached. In the case where it is determined that the update date has not been reached (No in Step S1), the processing of the controller 20 returns to the processing of Step S1 and stands by. The controller 20 determines, on the basis of the output of a timekeeping unit (not shown) included in the headquarters server 2, whether or not the update date has been reached.

In the case where it is determined that the update date has been reached (Yes in Step S1), the processing of the controller proceeds to Step S2. In Step S2, the member property management unit 2005 of the controller 20 extracts the purchase information of one member during a predetermined time period (e.g., one month in the previous month) from the purchase information management file 214. Subsequently, in Step S3, the member property management unit 2005 of the controller 20 extracts, from the product property information file 218, the property information corresponding to the product code included in the extracted purchase information. The extraction of property information is performed on all product codes included in the purchase information. That is, the member property management unit 2005 performs extraction of property information on all products purchased by one member during a predetermined time period.

In Step S4, the member property management unit 2005 of the controller 20 selects the top-three property information with a large number of extractions of the pieces of extracted property information described above (Step S3). Subsequently, in Step S5, the member property management unit 2005 of the controller 20 updates the consumer property information file 219. Specifically, the member property management unit 2005 overwrites the property information selected in Step S4 in the items of the property 3, the property 4, and the property 5 corresponding to the member ID of one member whose purchase information has been extracted.

Subsequently, in Step S6, the controller 20 determines whether or not the update of pieces of property information of all members registered in the consumer property information file 219 has been completed. In the case where it is determined that the update of pieces of property information of all members has not been completed (No in Step S6), the processing of the controller 20 returns to Step S2. The processing of Step S2 to Step S6 is repeated until the pieces of property information of all members are updated. In the case where it is determined that the update of pieces of property information of all members has been completed (Yes in Step S6), the controller 20 ends the consumer-property-information-management processing.

The controller 20 is capable of managing property information corresponding to the change of the consumer's taste or the like by periodically updating the consumer property information file 219 by the consumer-property-information-management processing.

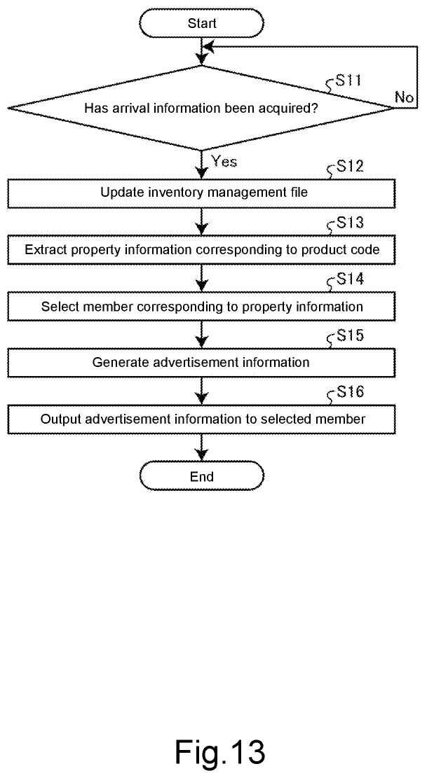

Subsequently, the advertisement information output processing executed by the headquarters server 2 will be described. FIG. 13 is a flowchart showing advertisement information output processing by the controller 20.

In Step S11 shown in FIG. 13, the controller 20 determines whether or not the acquisition unit 2001 has acquired arrival information and a product code from the store server 3. In the case where it is determined that the acquisition unit 2001 has not acquired arrival information and a product code (No in Step S11), the processing of the controller 20 returns to the processing of Step S11 and stands by.

In the case where it is determined that the acquisition unit 2001 has acquired arrival information and a product code (Yes in Step S11), the processing of the controller 20 proceeds to Step S12. In Step S12, the inventory management unit 2002 of the controller 20 updates the inventory management file 215. The inventory management unit 2002 updates the inventory management file 215 on the basis of the product code acquired by the acquisition unit 2001 and the number-of-products information acquired together with the product code.

In more detail, the inventory management unit 2002 updates, in the case where the product code acquired by the acquisition unit 2001 has been registered in the inventory management file 215, the stock quantity stored in association with the product code to the stock quantity obtained by adding the number of products that have arrived to the original stock quantity. Further, the inventory management unit 2002 registers, in the case where the product code acquired by the acquisition unit 2001 has not been registered in the inventory management file 215, the store code, the product code, and the number-of-products information acquired by the acquisition unit 2001 in the inventory management file 215.

Subsequently, in Step S13, the selection unit 2006 of the controller 20 refers to the product property information file 218 to extract the property information corresponding to the product code acquired by the acquisition unit 2001. In Step S14, the selection unit 2006 refers to the consumer property information file 219 to select a member for whom the extracted property information has been registered. The selection unit 2006 selects a member for whom all of a plurality of pieces of property information corresponding to the product code acquired by the acquisition unit 2001 have been registered in association with his/her member ID. Such selection is made in order to select a member who more closely matches the properties of the product that has arrived. However, the selection unit 2006 may select a member for whom one of a plurality of pieces of property information corresponding to the product code acquired by the acquisition unit 2001 has been registered in association with his/her member ID. Further, the selection unit 2006 may select a predetermined member. For example, the selection unit 2006 may select a predetermined excellent customer. As a result, it is possible to deliver advertisement information to only excellent customers at an early stage.

Subsequently, in Step S15, the generation unit 2007 of the controller 20 generates advertisement information of the arrived product identified by the product code acquired by the acquisition unit 2001. For example, the generation unit 2007 refers to the product master 213 to read the product information corresponding to the product code acquired by the acquisition unit 2001 and takes in the read product information into a preset format to generate advertisement information of the arrived product.

In Step S16, the output unit 2008 of the controller 20 outputs the advertisement information generated by the generation unit 2007 (Step S15) to the user terminal 4 of the member selected by the selection unit 2006 (Step S14). The controller 20 then ends the advertisement information output processing.

The controller 20 is capable of providing, to the consumer who is thought to match the arrived product by advertisement information output processing, advertisement information of the arrived product. Specifically, the controller 20 is capable of outputting advertisement information to the user terminal 4 of the consumer specified by the member ID registered in association with the same property information as the property information of the arrived product in the consumer property information file 219. As a result, each store 52 can be expected to improve the sales of the arrived product and the consumer can acquire advertisement information of the arrived product at an early stage. Further, since the controller 20 outputs advertisement information by utilizing information of the arrived product necessary for inventory management, it is unnecessary to separately provide a sensor or the like for recognizing that a product can be sold.

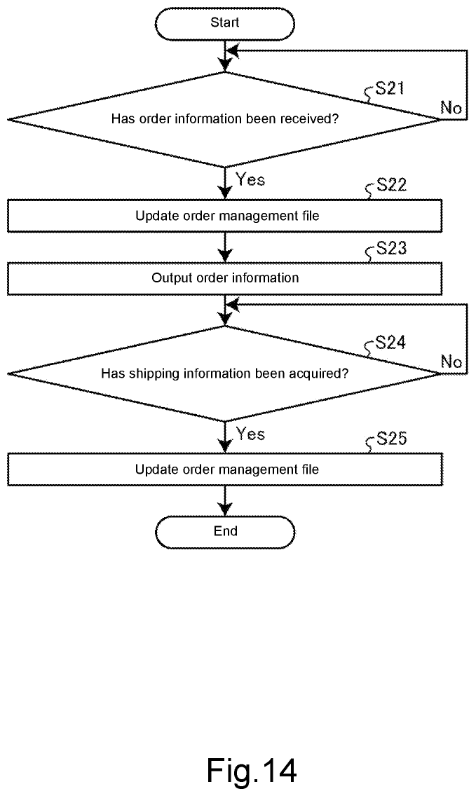

Subsequently, order information reception processing executed by the headquarters server 2 will be described. FIG. 14 is a flowchart showing order information reception processing by the controller 20.

In Step S21 shown in FIG. 14, the controller 20 determines whether or not the reception unit 2003 has received order information from the user terminal 4. In the case where it is determined that the reception unit 2003 has not received order information from the user terminal 4 (No in Step S21), the processing of the controller 20 returns to the processing of Step S21 and stands by.

In the case where it is determined that the reception unit 2003 has received order information from the user terminal 4 (Yes in Step S21), the processing of the controller 20 proceeds to Step S22. In Step S22, the order management unit 2004 of the controller 20 updates the order management file 216. The order management unit 2004 registers the order information received by the reception unit 2003 in the order management file 216.

Subsequently, in Step S23, the output unit 2008 of the controller 20 outputs the order information received by the reception unit 2003 to the store server 3. In more detail, the output unit 2008 outputs, to the store server 3 of the store 52 specified by the store code included in the order information received by the reception unit 2003, the order information.

Subsequently, in Step S24, the controller 20 determines whether or not the acquisition unit 2001 has acquired shipping information indicating that the ordered product has been shipped. For example, the controller 20 determines whether or not the acquisition unit 2001 has acquired purchase information including the member ID, the store code, and the product code included in the order information. In the case where it is determined that the acquisition unit 2001 has not acquired shipping information (No in Step S24), the processing of the controller 20 returns to the processing of Step S24 and stands by until shipping information is acquired.

In the case where it is determined that the acquisition unit 2001 has acquired shipping information indicating that the ordered product has been shipped (Yes in Step S24), the processing of the controller 20 proceeds to Step S25. In Step S25, the order management unit 2004 of the controller 20 updates the order management file 216. Specifically, the order management unit 2004 registers, on the basis of the information regarding the transaction date and time included in the purchase information, information indicating the shipping date, in other words, the transaction date in the item of the shipping date of the order management file 216. The controller 20 then ends the order information reception processing.

The controller 20 is capable of appropriately managing, by the order information reception processing, the order information from the user terminal 4 made for the advertisement information output by the output unit 2008.

Next, a modification of the headquarters server 2 will be described. FIG. 15 is a block diagram showing a configuration of the memory 21 according to the modification. The memory 21 further stores the individual-item-property-information file 220.

The individual-item-property-information file 220 is a file for storing property information defined for each individual item of products and stores the individual code that is the individual-item identification information and property information indicating the properties of the individual item in association with each other. The property information registered in the product property information file 218 is property information set in a company that operates the plurality of stores 52, in other words, property information commonly applied to each store 52. Meanwhile, the property information registered in the individual-item-property-information file 220 is property information individually set in each store 52. In the modified example, the individual-item-property-information file 220 is generated on the basis of the product property information file 218 and the arrival information acquired by the acquisition unit 2001.

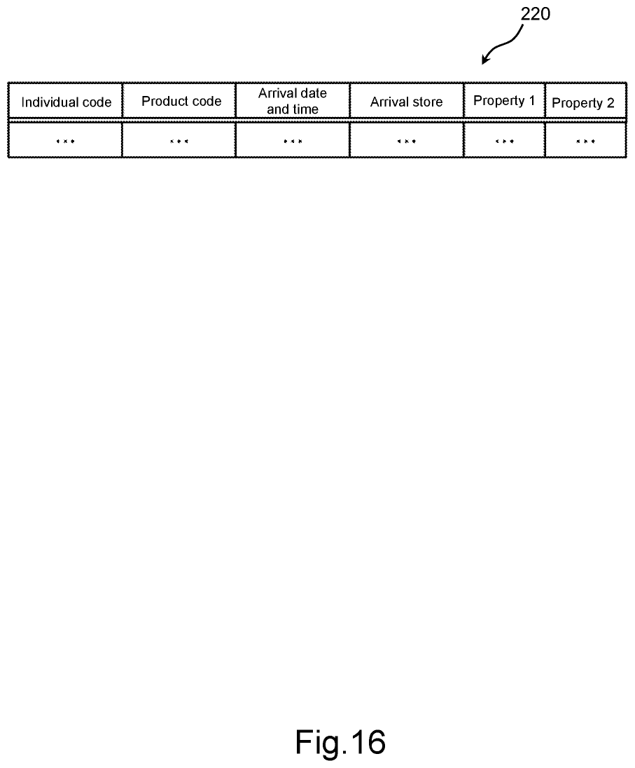

FIG. 16 is a diagram showing a data configuration of the individual-item-property-information file 220. Each piece of data registered in the individual-item-property-information file 220 is associated with information indicating an individual code, a product code, an arrival date and time, an arrival store, the property 1, and the property 2. Note that the number of pieces of property information determined in advance in association with the individual code is not limited to two and can be arbitrarily set. Further, the number of pieces of corresponding property information may be changed for each individual item.

An individual code for identifying the individual item is registered in the item of the individual code. A product code indicating what product the individual item is is registered in the item of the product code. Information indicating the date and time when the individual item arrived is registered in the item of the arrival date and time. A store code for identifying the store that sells the individual item is registered in the item of the arrival store. Property information indicating the properties of the individual item is registered in each of the items of the property 1 and the property 2. Note that the individual-item-property-information file 220 may include an item of an image for registering image data obtained by imaging an individual item.

In the case where the individual item is an “organic vegetable lunch box”, for example, information indicating a “lunch box” is registered in the item of the property 1. It can be said that the information indicating a “lunch box” indicates the properties of the individual item and also the properties of the product. Further, since an “organic vegetable lunch box” sells well during, for example, a lunch time zone in the store 52 identified by the store code registered in the item of the arrival store, information indicating a “lunch time zone” is registered in the item of the property 2. In the case where an “organic vegetable lunch box” sells well during a dinner time zone in another store 52, information indicating a “dinner time zone” is registered in the item of the property 2. The pieces of property information registered in the items of the property 1 and the property 2 described above are merely examples, and may be different property information indicating the properties of an individual item. For example, in the case where the product is a fruit, information indicating the sugar content measured for each individual item may be used as property information.

In the above-mentioned example, a member to be provided with advertisement information of the arrived product has been selected by matching between the property information of the arrived product and the property information of a consumer. Meanwhile, in a modification, a member to be provided with advertisement information of the individual item of the arrived product is selected by matching between the property information of the individual item of the arrived product and the property information of a consumer. Specifically, in advertisement information output processing according to the modified example, the processing of Step S13 shown in FIG. 13 is replaced with “extraction of property information corresponding to the individual code”. According to this modification, it is possible to provide more useful advertisement information to a consumer.

As described above, the controller 20 of the headquarters server 2 according to the embodiment includes the acquisition unit 2001 that acquires, when a product has arrived, product identification information for identifying the product that has arrived and the output unit 2008 that outputs, when the acquisition unit 2001 has acquired the product identification information, advertisement information of the product identified by the product identification information to the user terminal 4 of the consumer.

As a result, the headquarters server 2 is capable of more quickly providing information regarding a product to be sold, to a customer.

Further, the controller 20 of the headquarters server 2 according to the embodiment further includes the generation unit 2007 that extracts, from a product file (the product master 213) for storing product identification information (product code) and product information relating to the product in association with each other, the product information corresponding to the product identification information acquired by the acquisition unit 2001 and generates advertisement information on the basis of the product information.

As a result, the headquarters server 2 is capable of arbitrarily generating advertisement information on the basis of the product information stored in the product file (the product master 213).

Further, the controller 20 of the headquarters server 2 according to the embodiment further includes a first selection unit (the selection unit 2006) that refers to the product property information file 218 for storing, when the acquisition unit 2001 has acquired product identification information, the product identification information and property information indicating the properties of a product in association with each other and the consumer property information file 219 for storing consumer identification information for identifying a consumer and the property information in association with each other to select a consumer to be provided with advertisement information.

As a result, the headquarters server 2 is capable of providing, to a consumer who is thought to match the arrived product, i.e., a consumer who is thought to have a high possibility of purchasing the arrived product, advertisement information of the arrived product. For this reason, the headquarters server 2 is capable of delivering effective advertisement information.

In addition, in the headquarters server 2 according to the embodiment, the acquisition unit 2001 acquires the individual-item identification information for specifying the individual item of a product that has arrived. The controller 20 further includes a second selection unit (the selection unit 2006) that refers to, when the acquisition unit 2001 has acquired the individual-item identification information, the individual-item-property-information file 220 and the consumer property information file 219 to select a consumer to be provided with advertisement information. The individual-item-property-information file 220 stores the individual-item identification information and property information indicating the properties of an individual item in association with each other. The consumer property information file 219 stores consumer identification information for identifying a consumer and the property information in association with each other.

As a result, the headquarters server 2 is capable of more effectively delivering advertisement information.

Further, the controller 20 of the headquarters server 2 according to the embodiment includes a purchase information acquisition unit (the acquisition unit 2001) that acquires purchase information including consumer identification information and product identification information of a product purchased by the consumer identified by the consumer identification information. Further, the controller 20 includes an updating unit (the member property management unit 2005) that updates the consumer property information file 219 on the basis of the purchase information acquired by the purchase information acquisition unit (the acquisition unit 2001).

As a result, the headquarters server 2 is capable of updating, in accordance with the purchase trend of a consumer, the property information of the consumer. For this reason, the headquarters server 2 is capable of more appropriately selecting a consumer to whom advertisement information is delivered.

Note that in the embodiment described above, the control program executed by the headquarters server 2, the store server 3, and the user terminal 4, which are information processing apparatuses, may be recorded on a computer-readable recording medium such as a CD-ROM and provided. Further, the control program executed by the headquarters server 2, the store server 3, and the user terminal 4 according to the embodiment described above may be stored on a computer connected to a network such as the Internet, downloaded via the network, and provided, and may be provided via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing system comprising:
a store sever that manages inventory information of products in a store;
a sensor provided at a delivery receiving region of the store and configured to read, from a product that has been delivered to the store, product identification information for identifying the product; and
a main server that controls delivery of advertisement information to an information terminal of a consumer, the main server comprising:
a communication device that communicates with the store server and the information terminal;
a memory that includes a product master file for storing product information regarding products and a consumer property information file for storing consumer identification information for identifying consumers; and
a controller configured to
determine whether or not the product identification information read by the sensor has been received from the store server via the communication device,
when determining that the product identification information read by the sensor has been received, acquire product information associated with the received product identification information from the product master file,
generate advertisement information based on the product information acquired from the product master file,
select consumer identification information of a consumer that matches the product identified by the received product identification information from the consumer property information file as identification information of a consumer to whom the generated advertisement information should be delivered, and
output the generated advertisement information to the information terminal of the consumer identified by the selected consumer identification information via the communication device.

2. The information processing system according to claim 1, wherein
the product master file of the memory stores the product identification information and the product information in association with each other, and
the product information includes a product name, a product price, and a product image.

3. The information processing system according to claim 2, wherein
the controller extracts, from the product master file, the product information associated with the received product identification information.

4. The information processing system according to claim 3, wherein
the controller takes in the extracted product information into a preset format to generate the advertisement information.

5. The information processing system according to claim 1, wherein
the memory further includes a product property information file, the product property information file storing the product identification information and property information indicating properties of a product in association with each other, the consumer property information file storing consumer identification information for identifying a consumer and the property information with each other, and
the controller
refers to, upon acquiring the product identification information, the product property information file and the consumer property information file and selects a consumer to be provided with the advertisement information, and
outputs, to the information terminal of the selected consumer, the advertisement information via the communication device.

6. The information processing system according to claim 5, wherein
the controller
extracts, from the product property information file, the property information corresponding to the acquired product identification information, and
selects a consumer identified by consumer identification information corresponding to the extracted property information in the consumer property information file.

7. The information processing system according to claim 1, wherein
the memory further includes an individual-item-property-information file and a consumer property information file, the individual-item-property-information file storing individual-item identification information for specifying an individual item of a product and property information indicating properties of the individual item of the product in association with each other, the consumer property information file storing consumer identification information for identifying a consumer and the property information with each other, and
the controller further acquires, when determining that the product identification information read by the sensor has been received, the individual-item identification information for specifying the individual item of the product that has arrived from the store server via the communication device.

8. The information processing system according to claim 7, wherein
the controller
refers to, upon acquiring the individual-item identification information, the individual-item-property-information file and the consumer property information file to select a consumer to be provided with the advertisement information, and
outputs, to the information terminal of the selected consumer, the advertisement information via the communication device.

9. The information processing system according to claim 5, wherein
the controller
further acquires, from the store server via the communication device, purchase information including the consumer identification information and product identification information of a product purchased by a consumer identified by the consumer identification information, and
updates the consumer property information file on a basis of the acquired purchase information.

10. (canceled)
